(19) United States
(12) Patent Application Publication
(10) Pub. No.: US 2021/0048504 A1
(43) Pub. Date: Feb. 18, 2021

(54) POSITIONING DEVICE, POSITIONING METHOD, AND POSITIONING SYSTEM

(71) Applicant: Mitsubishi Electric Corporation, Tokyo (JP)

(72) Inventors: Ryo HAYAKAWA, Tokyo (JP); Takashi ASAHARA, Tokyo (JP)

(73) Assignee: Mitsubishi Electric Corporation, Tokyo (JP)

(21) Appl. No.: 17/086,802

(22) Filed: Nov. 2, 2020

Related U.S. Application Data
(63) Continuation of application No. PCT/JP2018/024038, filed on Jun. 25, 2018.

(51) Int. Cl. G01S 5/02; G01S 5/14

(52) U.S. Cl. CPC G01S 5/0244; G01S 5/14

(57) ABSTRACT

A communication unit (23) treats each of a plurality of nearby devices that are present in the vicinity and whose positions are already known as a target nearby device, and receives a position of the target nearby device from the target nearby device. A device selection unit (21) selects at least one nearby device to be used from among the plurality of nearby devices, based on an overall accuracy of the target nearby device calculated using a position accuracy that is an accuracy of the position received from the target nearby device by the communication unit and a distance accuracy that is an accuracy of a distance to the target nearby device. A position estimation unit (22) estimates a position, based on the position received from the nearby device selected by the device selection unit (21) and a distance to the selected nearby device.

### CROSS REFERENCE TO RELATED APPLICATION

This application is a Continuation of PCT International Application No. PCT/JP2018/024038, filed on Jun. 25, 2018, which is hereby expressly incorporated by reference into the present application.

### TECHNICAL FIELD

The present invention relates to a technology for estimating a position based on information obtained from a nearby device whose position has already been estimated.

### BACKGROUND ART

Position information is being used for services such as navigation and equipment management, and is of increasing value. For outdoor positioning, a method using the Global Positioning System (GPS) is widely used. For indoor and underground positioning, where radio waves of satellites do not reach, technologies using media such as a wireless local area network (LAN), Bluetooth (registered trademark), ultra-wideband (UWB), and acoustic waves have been proposed.

In these technologies, depending on the characteristics or specifications of a medium, the distance between a positioning device and a positioning target is estimated employing a method of estimating the distance using received signal strength indication (RSSI) of radio waves transmitted by the positioning device or a method of estimating the distance using time of arrival (TOA) of the medium. Then, the position of the positioning target is estimated based on the position of the positioning device and the estimated distance.

The transmission distances of the media used for indoor and underground position estimation are approximately several meters to several tens of meters. Therefore, when a system is applied on a large scale, a large number of positioning devices need to be installed. A great deal of work is required to measure the positions of all positioning devices and set the measurement results. For this reason, it is desired that the positions of positioning devices be measured and set automatically.

Patent Literature 1 describes a method in which the position of a positioning device whose position is unknown is estimated using a positioning device whose position is already known, and this is repeated until the positions of all positioning devices are estimated. Patent Literature 2 describes a method in which a tag whose position is already known and a positioning device whose position is unknown are used to set the position of the positioning device.

### CITATION LIST

### Patent Literature

Patent Literature 1: JP 2010-151807 A

Patent Literature 2: JP 2010-175536 A

### SUMMARY OF INVENTION

### Technical Problem

The methods described in Patent Literature 1 and Patent Literature 2 are methods in which the position of a positioning device is estimated and the position of the positioning device is set. In Patent Literature 1 and Patent Literature 2, errors that occur in position estimation are not considered, so that errors accumulate as the positioning device repeatedly estimates positions. A positioning system constructed using positioning devices with large accumulated errors has a low position-estimation reliability.

It is an object of the present invention to reduce an error that occurs in position estimation.

### Solution to Problem

A positioning device according to the present invention includes:

a communication unit to treat each of a plurality of nearby devices that are present in a vicinity and whose positions are already known as a target nearby device, and receive a position of the target nearby device from the target nearby device;

a device selection unit to select at least one nearby device to be used from among the plurality of nearby devices, based on an overall accuracy of the target nearby device calculated using a position accuracy that is an accuracy of the position received from the target nearby device by the communication unit and a distance accuracy that is an accuracy of a distance to the target nearby device; and

a position estimation unit to estimate a position, based on the position received from the nearby device selected by the device selection unit and a distance to the selected nearby device.

### Advantageous Effects of Invention

In the present invention, a nearby device to be used is selected based on an overall accuracy of each target nearby device calculated using a position accuracy and a distance accuracy, and then a position is estimated. As a result, an error that occurs in position estimation can be reduced.

### BRIEF DESCRIPTION OF DRAWINGS

FIG. 1 is a configuration diagram of a positioning system 100 according to a first embodiment;

FIG. 2 is a configuration diagram of a positioning device 10 according to the first embodiment;

FIG. 3 is a diagram illustrating an example of a configuration of the positioning system 100 according to the first embodiment;

FIG. 4 is a flowchart illustrating operation of a positioning device 10 in the vicinity of a positioning device 10 whose position is to be estimated according to the first embodiment;

FIG. 5 is a flowchart illustrating operation of the positioning device 10 whose position is to be estimated according to the first embodiment;

FIG. 6 is a diagram describing an example of operation to sequentially estimate the positions of positioning devices 10 in the positioning system 100 according to the first embodiment;

FIG. 7 is a processing flow diagram of operation to sequentially estimate the positions of the positioning devices 10 in the positioning system 100 according to the first embodiment;

FIG. 8 is a flowchart of a process of one positioning device 10 according to the first embodiment;

FIG. 9 is a flowchart of a position accuracy calculation process according to the first embodiment;

FIG. 10 is a diagram describing differences in distance accuracies based on the positional relationships between the positioning devices 10 whose positions are already known and the positioning device 10 whose position is unknown according to the first embodiment;

FIG. 11 is a configuration diagram of the positioning device 10 according to a second variation;

FIG. 12 is a diagram describing an example of operation to select a nearby device to be used for position estimation in the positioning system 100 according to a second embodiment;

FIG. 13 is a configuration diagram of the positioning device 10 according to a third embodiment;

FIG. 14 is a diagram describing an example of operation to select a nearby device to be used for position estimation in the positioning system 100 according to the third embodiment;

FIG. 15 is a configuration diagram of the positioning device 10 according to a fourth embodiment; and

FIG. 16 is a diagram describing an example of operation to select a nearby device to be used for position estimation in the positioning system 100 according to the fourth embodiment.

### DESCRIPTION OF EMBODIMENTS

### First Embodiment

***Description of Configurations***

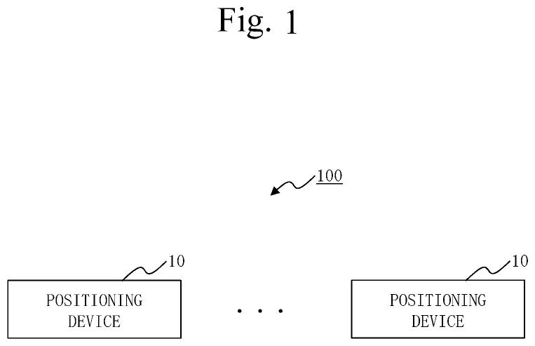

Referring to FIG. 1, a configuration of a positioning system 100 according to a first embodiment will be described.

The positioning system 100 includes a plurality of positioning devices 10. When the plurality of positioning devices 10 are placed in proximity to one another, they can communicate by methods such as a wireless LAN, Bluetooth (registered trademark), and UWB.

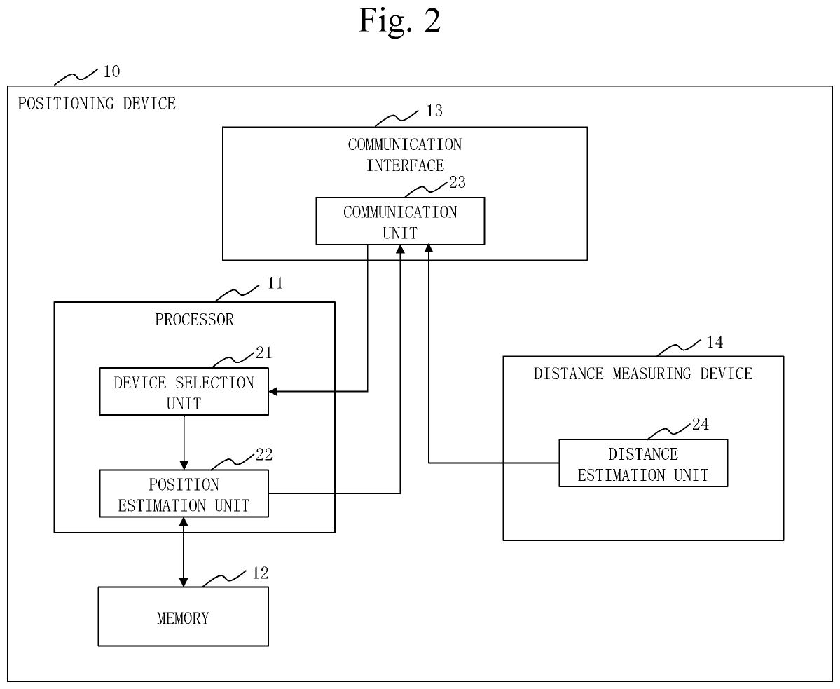

Referring to FIG. 2, a configuration of the positioning device 10 according to the first embodiment will be described.

The positioning device 10 is a computer.

The positioning device 10 includes hardware of a processor 11, a memory 12, a communication interface 13, and a distance measuring device 14. The processor 11 is connected with the other hardware components via signal lines and controls the other hardware components.

The processor 11 is an integrated circuit (IC) that performs processing. Specific examples of the processor 11 are a central processing unit (CPU), a digital signal processor (DSP), and a graphics processing unit (GPU).

The memory 12 is a storage device to store data. Specific examples of the memory 12 are a static random access memory (SRAM) and a dynamic random access memory (DRAM). The memory 12 may be a portable recording medium, such as a Secure Digital (SD, registered trademark) memory card, CompactFlash (CF, registered trademark), a NAND flash, a flexible disk, an optical disc, a compact disc, a Blu-ray (registered trademark) disc, or a digital versatile disk (DVD).

The communication interface 13 is an interface for communicating with external devices. Specific examples of the communication interface 13 are an Ethernet (registered trademark) port, a Universal Serial Bus (USB) port, and a High-Definition Multimedia Interface (HDMI, registered trademark) port.

The distance measuring device 14 is a device that measures the distance to another positioning device 10. Specific examples of the distance measuring device 14 are a UWB transceiver and devices such as a microphone and a speaker.

The positioning device 10 includes, as functional components, a device selection unit 21, a position estimation unit 22, a communication unit 23, and a distance estimation unit 24. The functions of the device selection unit 21 and the position estimation unit 22 are realized by the processor 11. The function of the communication unit 23 is realized by the communication interface 13. The function of the distance estimation unit 24 is realized by the distance measuring device 14.

The functions of the device selection unit 21 and the position estimation unit 22 are realized by software. The memory 12 stores programs for realizing the functions of the device selection unit 21 and the position estimation unit 22. These programs are loaded and executed by the processor 11. This realizes the functions of the device selection unit 21 and the position estimation unit 22.

The functions of the communication unit 23 and the distance estimation unit 24 may also be realized by software as in the case of the functions of the device selection unit 21 and the position estimation unit 22.

FIG. 1 illustrates only one processor 11. However, a plurality of processors 11 may be included, and the plurality of processors 11 may cooperate to execute the programs for realizing the functions.

***Description of Operation***

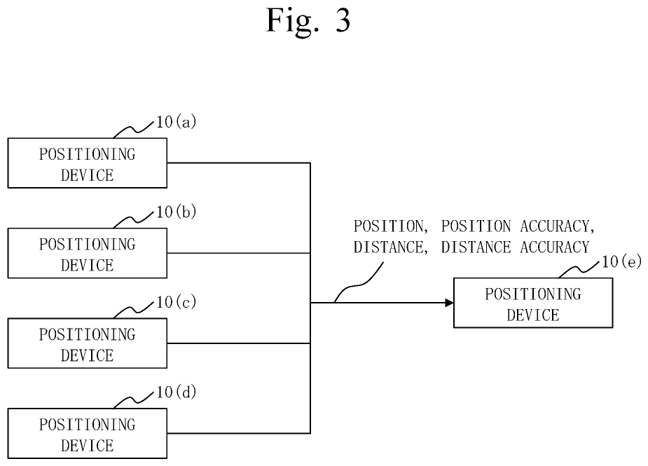

Referring to FIGS. 3 to 10, operation of the positioning system 100 according to the first embodiment will be described.

The operation of the positioning system 100 according to the first embodiment corresponds to a positioning method according to the first embodiment. The operation of the positioning system 100 according to the first embodiment also corresponds to processes of a positioning program according to the first embodiment.

Referring to FIGS. 3 to 5, a positioning process of the positioning system 100 according to the first embodiment will be described.

In FIG. 3, the positioning system 100 includes five positioning devices 10, a positioning device 10(a) to a positioning device 10(e).

An example in which the position of the positioning device 10(e) is estimated will be described here. It is assumed that the positions of the positioning device 10(a) to the positioning device 10(d) are already known. That the position is already known means that the position has been estimated by a method to be described below, or the position has been determined by some method such as manually. In the memory 12 of each of the positioning device 10(a) to the positioning device 10(d) whose positions are already known, the position of the positioning device itself and a position accuracy, which is the accuracy of the position, are stored. It is assumed that the positioning device 10(a) to the positioning device 10(d) are located within a communication range of the communication unit 23 of the positioning device 10(e).

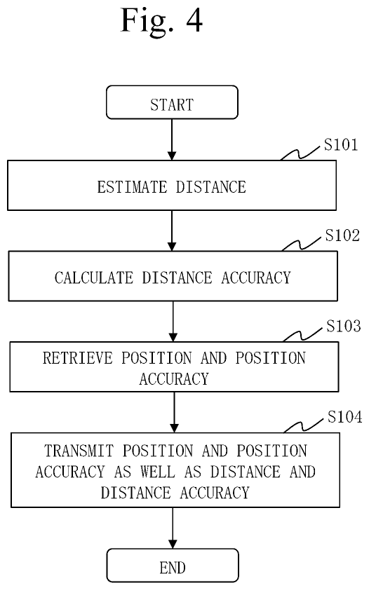

Referring to FIG. 4, operation of each positioning device 10 of the positioning device 10(a) to the positioning device 10(d) will be described.

In step S101, the distance estimation unit 24 estimates the distance to the positioning device 10(e) whose position is to be estimated. At this time, the distance estimation unit 24 may cooperate with the distance estimation unit 24 of the positioning device 10(e) to estimate the distance. Specifically, the distance estimation unit 24 estimates the distance by a method such as the RSSI method or the TOA method, using a medium such as a wireless LAN, Bluetooth (registered trademark), UWB, or acoustic waves. The distance estimation unit 24 may estimate the direction of the positioning device 10(e) by an angle of arrival (AOA) method or the like.

In step S102, the distance estimation unit 24 calculates a distance accuracy, which is the accuracy of the estimated distance, based on physical conditions such as the length of the estimated distance, the magnitude of noise such as a signal-to-noise (S/N) ratio when estimating the distance, the signal strength of the medium, and the presence or absence of multipath. The distance estimation unit 24 transmits the distance accuracy together with the distance estimated in step S101 to the communication unit 23.

In step S103, the position estimation unit 22 retrieves the position and position accuracy stored in the memory 12 and transmits them to the communication unit 23.

In step S104, the communication unit 23 transmits the position and position accuracy transmitted in step S103 and the distance and distance accuracy transmitted in step S102 to the positioning device 10(e).

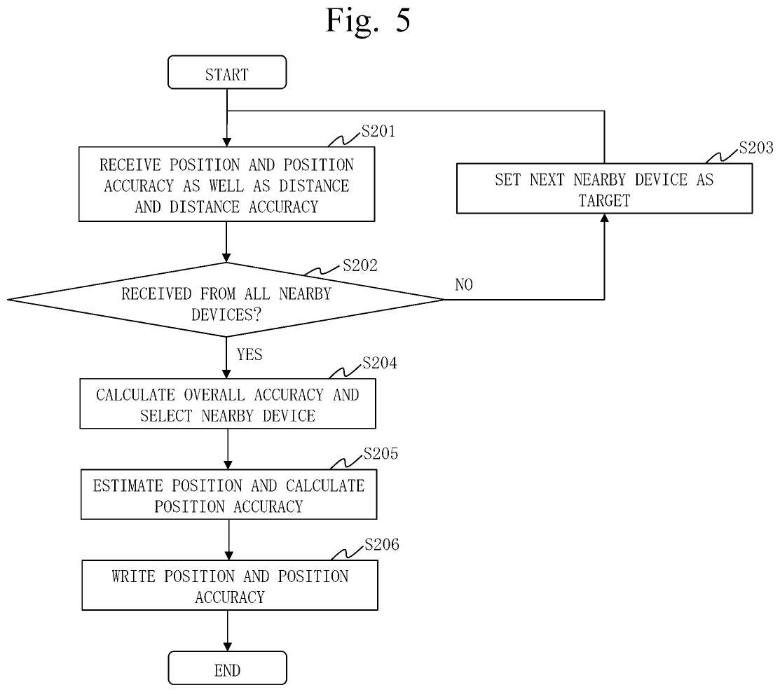

Referring to FIG. 5, operation of the positioning device 10(e) will be described.

In steps S201 to S203, the communication unit 23 sets, as a target nearby device, each of the positioning device 10(a) to the positioning device 10(d) whose positions within the communication range have already been estimated. The communication unit 23 receives, from each target nearby device, the position of the target nearby device and the position accuracy as well as the distance from the target nearby device and the distance accuracy. The communication unit 23 transmits the received position and position accuracy as well as distance and distance accuracy to the device selection unit 21.

After transmitting the positions and position accuracies as well as distances and distance accuracies of all the target nearby devices to the device selection unit 21, the communication unit 23 advances the process to step S204.

In step S204, with regard to each target nearby device, the device selection unit 21 calculates an overall accuracy of that nearby device, based on the position accuracy and distance accuracy received from that target nearby device. The device selection unit 21 selects at least one nearby device to be used from among the nearby devices, based on the calculated overall accuracies.

Specifically, the device selection unit 21 selects a required number of nearby devices for the position estimation unit 22 to estimate the position in descending order of the overall accuracies. The required number for estimating the position varies with the positioning method. As a specific example, when the positioning method is the TOA method, three positioning devices 10 whose positions are already known are required. Therefore, the required number for estimating the position is three. That is, when the positioning method is the TOA method, the device selection unit 21 selects three positioning devices 10 from among the positioning device 10(a) to the positioning device 10(d) in descending order of the overall accuracies.

In step S205, the position estimation unit 22 estimates the position of the positioning device 10(e) based on the position and distance received from the nearby device selected in step S204. The position estimation unit 22 also calculates a position accuracy, which is the accuracy of the estimated position, based on the position accuracy and distance accuracy of the at least one nearby device selected in step S204.

In step S206, the position estimation unit 22 writes in the memory 12 the position of the positioning device 10(e) estimated in step S205 and the position accuracy with regard to the positioning device 10(e) calculated in step S205.

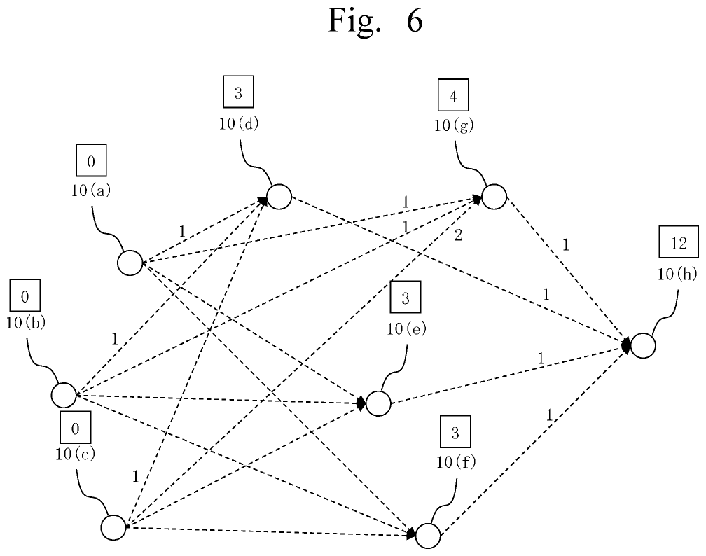

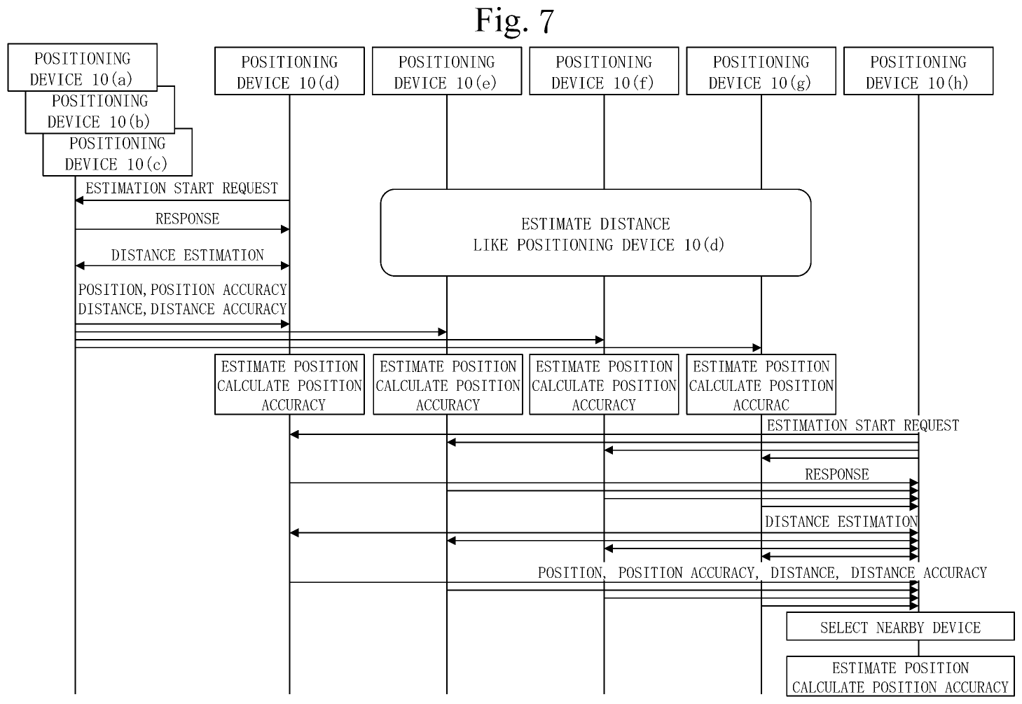

Referring to FIGS. 6 and 7, an example of operation to sequentially estimate the positions of the positioning devices 10 in the positioning system 100 according to the first embodiment will be described.

In FIG. 6, the positioning system 100 includes the positioning device 10(a) to the positioning device 10(h). The positions of the positioning device 10(a) to the positioning device 10(c) are already known. The positioning device 10(a) to the positioning device 10(c) are located within the communication ranges of the communication units 23 of the positioning device 10(d) to the positioning device 10(g) and outside the communication range of the communication unit 23 of the positioning device 10(h). The positioning device 10(d) to the positioning device 10(g) are located within the communication range of the communication unit 23 of the positioning device 10(h).

It is assumed here that the required number of the positioning devices 10 for position estimation is three. With regard to the position accuracy and the distance accuracy, smaller values signify higher accuracies. In FIG. 6, a numerical value indicated above each of the positioning devices 10 indicates the position accuracy of that positioning device 10.

As a first stage, the positions of the positioning device 10(d) to the positioning device 10(g) having the positioning device 10(a) to the positioning device 10(c) within the respective communication ranges are estimated first. This will be described using the positioning device 10(d) as an example here.

The positioning device 10(d) treats the positioning device 10(a) to the positioning device 10(c), which are located within the communication range and whose positions are already known, as target nearby devices and transmits an estimation start request to each of the target nearby devices. Then, each of the positioning device 10(a) to the positioning device 10(c) transmits a response to the estimation start request and estimates the distance to the positioning device 10(d). Then, each of the positioning device 10(a) to the positioning device 10(c) transmits the position and the position accuracy as well the distance and the distance accuracy to the positioning device 10(d).

The number of the target nearby devices of the positioning device 10(d) is three, which is the same as the required number of the positioning devices 10 for position estimation. Therefore, the positioning device 10(d) selects the positioning device 10(a) to the positioning device 10(c).

The positioning device 10(d) estimates the position based on the positions and distances transmitted from the positioning device 10(a) to the positioning device 10(c). The positioning device 10(d) also calculates the position accuracy, which is the accuracy of the estimated position, based on the position accuracies and distance accuracies transmitted from the positioning device 10(a) to the positioning device 10(c). In FIG. 6, the position accuracies of the positioning device 10(a), the positioning device 10(b), and the positioning device 10(c) are all 0. The distance accuracy between the positioning device 10(a) and the positioning device 10(d), the distance accuracy between the positioning device 10(b) and the positioning device 10(d), and the distance accuracy between the positioning device 10(c) and the positioning device 10(d) are all 1. Therefore, for example, the positioning device 10(d) calculates the position accuracy as 3 by summing the position accuracies and distance accuracies received from the positioning device 10(a) to the positioning device 10(c).

The positioning device 10(e) to the positioning device 10(g) perform substantially the same process as that of the positioning device 10(d). As a result, the positions of the positioning device 10(e) to the positioning device 10(g) are estimated, and the position accuracies of the estimated positions are calculated. In FIG. 6, the position accuracies of the positioning device 10(e) and the positioning device 10(f) are both calculated as 3, and the position accuracy of the positioning device 10(g) is calculated as 4. The distance accuracy between the positioning device 10(c) and the positioning device 10(g) is 2, which is different from the other distance accuracies, so that the position accuracy of the positioning device 10(g) is 4, which is different from the other position accuracies.

Next, as a second stage, the position of the positioning device 10(h) not having the positioning device 10(a) to the positioning device 10(c) within the communication range is estimated.

The positioning device 10(h) treats the positioning device 10(d) to the positioning device 10(g), which are located within the communication range and whose positions are already known, as target nearby devices and transmits an estimation start request to each of the target nearby devices. Then, each of the positioning device 10(d) to the positioning device 10(g) transmits a response to the estimation start request, and estimates the distance to the positioning device 10(h). Then, each of the positioning device 10(d) to the positioning device 10(g) transmits the position and the position accuracy as well as the distance and the distance accuracy to the positioning device 10(h).

The positioning device 10(h) calculates the overall accuracy based on the position accuracy and the distance accuracy for each of the positioning device 10(d) to the positioning device 10(g). The positioning device 10(h) treats the sum of the position accuracy and the distance accuracy as the overall accuracy here. In FIG. 6, the overall accuracies of the positioning device 10(d), the positioning device 10(e), and the positioning device 10(f) are 4, and the overall accuracy of the positioning device 10(g) is 5. Therefore, the positioning device 10(h) selects the positioning device 10(d), the positioning device 10(e), and the positioning device 10(f).

The positioning device 10(h) estimates the position based on the positions and distances transmitted from the positioning device 10(d) to the positioning device 10(f). The positioning device 10(h) also calculates the position accuracy, which the accuracy of the estimated position, based on the position accuracies and distance accuracies transmitted from the positioning device 10(d) to the positioning device 10(f). In FIG. 6, the position accuracies of the positioning device 10(d), the positioning device 10(e), and the positioning device 10(f) are all 3. The distance accuracy between the positioning device 10(d) and the positioning device 10(h), the distance accuracy between the positioning device 10(e) and the positioning device 10(h), and the distance accuracy between the positioning device 10(f) and the positioning device 10(h) are all 1. Therefore, for example, the positioning device 10(h) calculates the position accuracy as 12 by summing the position accuracies and distance accuracies received from the positioning device 10(d) to the positioning device 10(f).

As described above, as long as there is a positioning device 10 whose position is unknown, the position estimation process is performed repeatedly to sequentially determine the positions of the positioning devices 10.

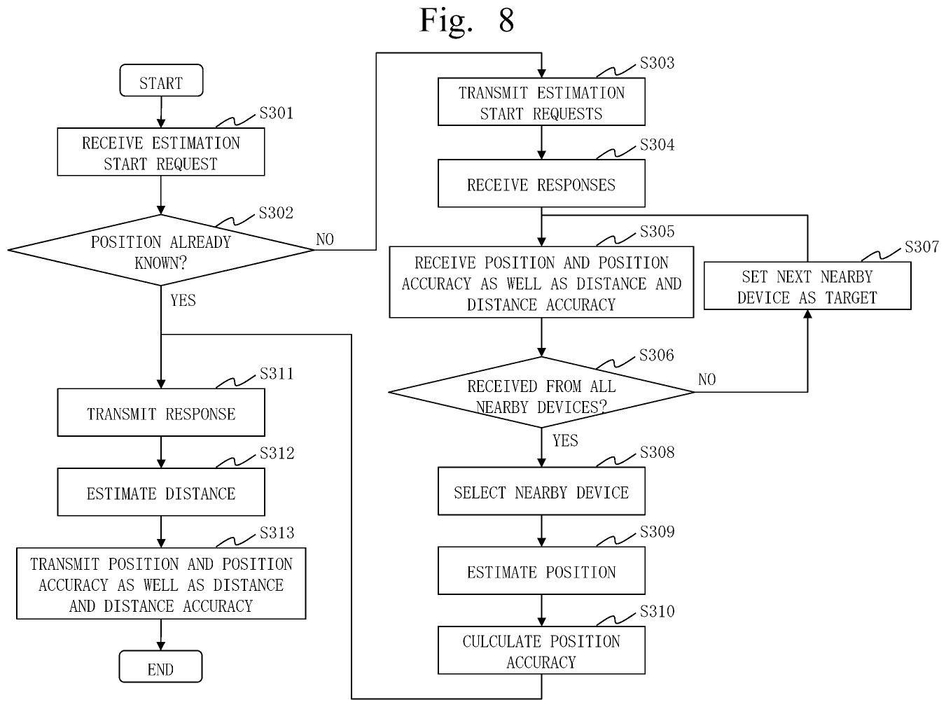

Referring to FIG. 8, a process of one positioning device 10 according to the first embodiment will be described.

In step S301, the communication unit 23 receives an estimation start request. In step S302, the position estimation unit 22 determines whether the position is already known. That is, the position estimation unit 22 determines whether the position has been determined manually or by another method, or whether the position has been estimated. If the position is unknown, the position estimation unit 22 advances the process to step S303. If the position is already known, the position estimation unit 22 advances the process to step S311.

In step S303, the communication unit 23 transmits estimation start requests to the positioning devices 10 in the vicinity in order to estimate the position. Then, the estimation start requests are received by nearby devices, which are the positioning devices 10 in the vicinity within the communication range. In step S304, the communication unit 23 receives responses from the nearby devices, which are the positioning devices 10 in the vicinity, that have received the estimation start requests.

In steps S305 to S307, the communication unit 23 receives a position and a position accuracy as well as a distance and a distance accuracy from each of the nearby devices that have transmitted the responses received in step S304.

In step S308, the device selection unit 21 selects a nearby device to be used. In step S309, the position estimation unit 22 estimates the position based on the position and distance received from the nearby device selected in step S308. In step S310, the position estimation unit 22 calculates the position accuracy of the position estimated in step S310, based on the position accuracy and distance accuracy received from the nearby device selected in step S308.

In step S311, the communication unit 23 transmits a response to the estimation start request received in step S301. In step S312, the distance estimation unit 24 estimates the distance to the positioning device 10 that has transmitted the estimation start request received in step S301. The distance estimation unit 24 also calculates the distance accuracy of the estimated distance. In step S313, the communication unit 23 transmits the position and the position accuracy, the distance estimated in step S312, and the distance accuracy calculated in step S312 to the positioning device 10 that has transmitted the estimation start request received in step S301.

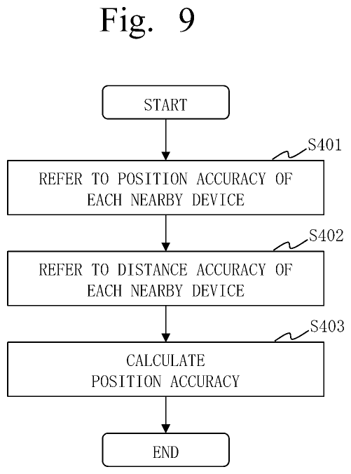

Referring to FIG. 9, a position accuracy calculation process according to the first embodiment will be described.

In step 401, the position estimation unit 22 refers to the position accuracy of the position of each nearby device used for estimating the position. In step S402, the position estimation unit 22 refers to the distance accuracy of the distance of each nearby device used for estimating the position.

In step S403, the position estimation unit 22 calculates the position accuracy of its own position based on the position accuracy of each nearby device referred to in step S401 and the distance accuracy of each nearby device referred to in step S402. As a specific example, the sum of the position accuracy and distance accuracy of each nearby device is calculated as the position accuracy of its own position.

At this time, the position estimation unit 22 may calculate the position accuracy by weighting values obtained from the position accuracy and the distance accuracy with physical information, such as the length of the distance to each nearby device used for estimating the position and noise of a medium used for estimating the position. As a specific example, the position estimation unit 22 calculates the position accuracy of its own position by weighting the sum of the position accuracy and the distance accuracy of each nearby device with physical information.

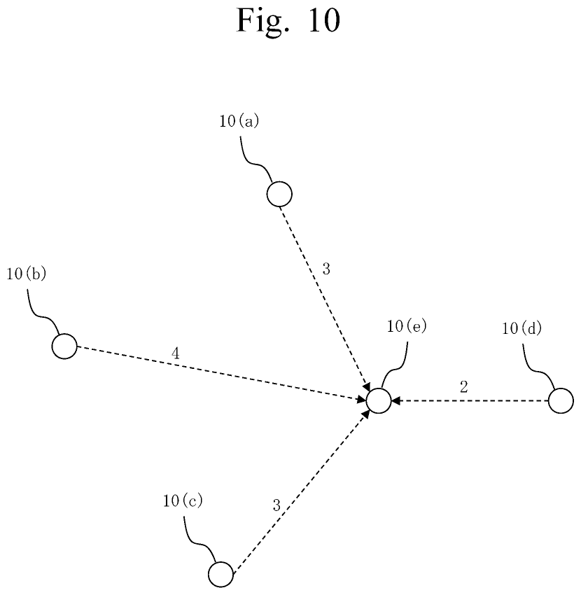

Referring to FIG. 10, differences in distance accuracies based on the positional relationships between the positioning devices 10 whose positions are already known and the positioning device 10 whose position is unknown will be described.

As a general rule, an error in distance estimation increases as the distance between the positioning devices 10 increases. Therefore, as a general rule, it is desirable that the position be estimated using the positioning device 10 whose position is already known and which is located near the positioning device 10 whose position is unknown.

In FIG. 10, the positioning system 100 includes the positioning device 10(a) to the positioning device 10(e). The positions of the positioning device 10(a) to the positioning device 10(d) are already known. The position of the positioning device 10(e) is unknown. It is assumed here that the required number of the positioning devices 10 for position estimation is three. Therefore, to estimate the position of the positioning device 10(e), three of the four positioning devices 10, the positioning device 10(a) to the positioning device 10(d), are used.

As a general rule, the distance accuracy has a greater value as the distance between the positioning devices 10 increases. However, this may not be the case depending on other factors such as noise. In FIG. 10, the positioning device 10(d) is closest to the positioning device 10(e), the positioning device 10(a) and the positioning device 10(c) are second closest to the positioning device 10(e), and the positioning device 10(b) is farthest from the positioning device 10(e). The distance accuracy between the positioning device 10(d) and the positioning device 10(e) is 2, the distance accuracy between the positioning device 10(a) and the positioning device 10(e) and the distance accuracy between the positioning device 10(c) and the positioning device 10(e) are 3, and the distance accuracy between the positioning device 10(b) and the positioning device 10(e) is 4.

Therefore, if the position accuracies of the positioning device 10(a) to the positioning device 10(d) are the same, the positioning device 10(a), the positioning device 10(c), and the positioning device 10(d) are used to estimate the position. That is, the positioning devices 10 at closer distances are used.

***Effects of First Embodiment***

As described above, the positioning system 100 according to the first embodiment selects the positioning device 10 to be used based on the overall accuracy of the positioning device 10 calculated using the position accuracy and the distance accuracy, and then estimates the position. As a result, an error that occurs in position estimation can be reduced.

In particular, the overall accuracy is calculated using the position accuracy, so that the positioning device 10 having a small error included in its position is used. The overall accuracy is calculated using the distance accuracy, so that the positioning device 10 having a small error included in the estimated distance, such as being located at a short distance, is used. As a result, an error that occurs in position estimation can be reduced.

***Other Configurations***

<First Variation>

In the first embodiment, the distance estimation unit 24 of the positioning device 10 whose position is already known estimates the distance to the positioning device 10 whose position is to be estimated, and transmits the distance to the positioning device 10 whose position is to be estimated. However, the distance estimation unit 24 of the positioning device 10 whose position is to be estimated may estimate the distance to the positioning device 10 whose position is already known. In this case, the distance estimation unit 24 of the positioning device 10 whose position is to be estimated also calculates the distance accuracy.

In this case, in steps S201 to S203 of FIG. 5, the communication unit 23 receives only a position and a position accuracy from the target nearby device. In step S204 of FIG. 5, the device selection unit 21 calculates, for each target nearby device, the overall accuracy of that target nearby device, based on the position accuracy received from that target nearby device and the distance accuracy calculated by the distance estimation unit 24 with respect to that target nearby device. In step S205 of FIG. 5, the position estimation unit 22 estimates the position based on the position received from the nearby device selected in step S204 and the distance calculated by the distance estimation unit 24 with respect to the nearby devices selected in step S204.

<Second Variation>

In the first embodiment, the functions of the device selection unit 21 and the position estimation unit 22 are realized by software. As a second variation, however, the functions of the device selection unit 21 and the position estimation unit 22 may be realized by hardware. With regard to this second variation, differences from the first embodiment will be described.

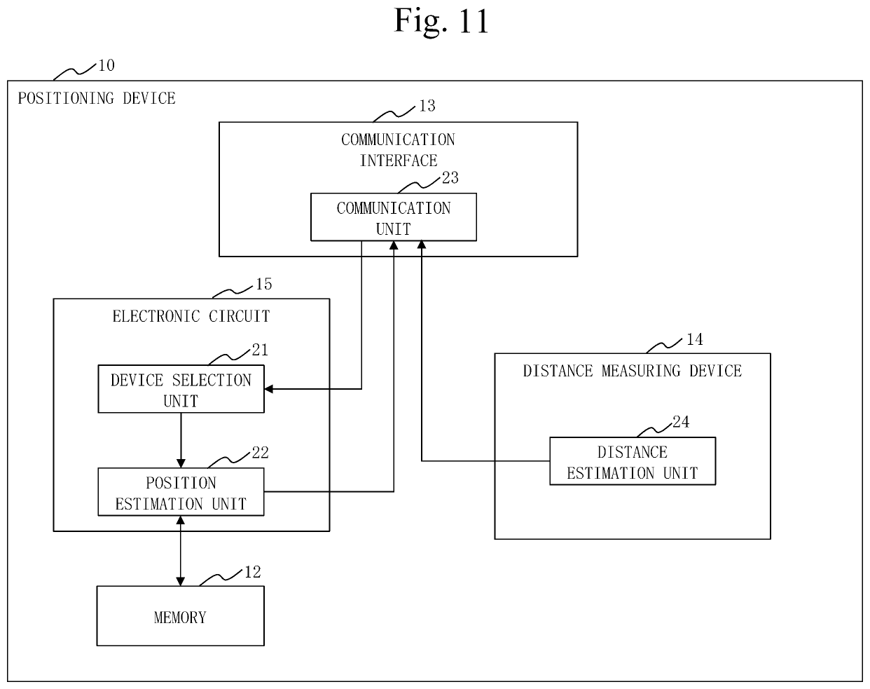

Referring to FIG. 11, a configuration of the positioning device 10 according to the second variation will be described.

When the functions of the device selection unit 21 and the position estimation unit 22 are realized by hardware, the positioning device 10 includes an electronic circuit 15 in place of the processor 11. The electronic circuit 15 is a dedicated circuit that realizes the functions of the device selection unit 21 and the position estimation unit 22.

The electronic circuit 15 is assumed to be a single circuit, a composite circuit, a programmed processor, a parallel-programmed processor, a logic IC, a gate array (GA), an application specific integrated circuit (ASIC), or a field-programmable gate array (FPGA).

The functional components may be realized by one electronic circuit 15, or the functional components may be distributed among and realized by a plurality of electronic circuits 15.

<Third Variation>

As a third variation, some of the functional components may be realized by hardware, and the rest of the functional components may be realized by software.

Each of the processor 11 and the electronic circuit 15 is referred to as processing circuitry. That is, the functions of the functional components are realized by the processing circuitry.

### Second Embodiment

A second embodiment differs from the first embodiment in that the overall accuracy is calculated based on a difference between the position of a target nearby device and a reference position. In the second embodiment, this difference will be described and description of the same aspects will be omitted.

The communication unit 23 of a nearby device also transmits a difference between the position and the reference position when transmitting the position and the position accuracy as well as the distance and the distance accuracy. The device selection unit 21 of the positioning device 10 whose position is to be estimated calculates the overall accuracy based on the position accuracy, the distance accuracy, and the difference. As a specific example, the device selection unit 21 calculates the overall accuracy by weighting values obtained from the position accuracy and the distance accuracy with the difference.

A specific example of the reference position is a position with a high accuracy such as a position set manually. The farther away from the reference position, the higher the probability that the accuracy of the position is low. Therefore, the overall accuracy is calculated such that the farther away from the reference position, the lower the accuracy. That is, the greater the difference, the lower the overall accuracy.

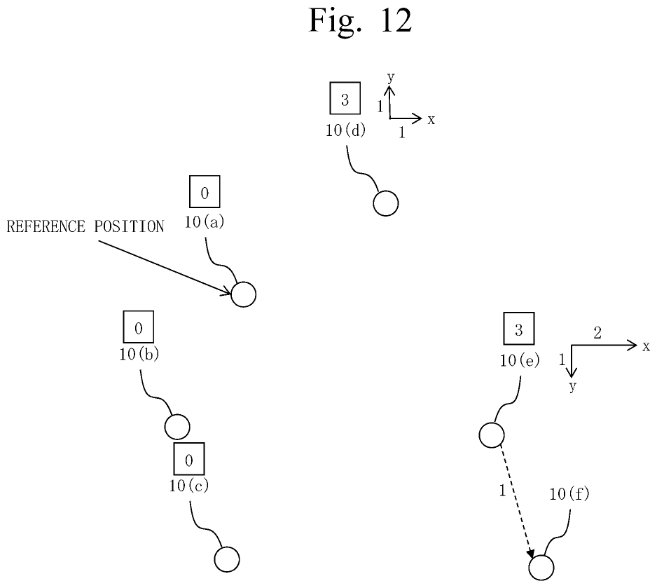

Referring to FIG. 12, an example of operation to select a nearby device to be used for position estimation in the positioning system 100 according to the second embodiment will be described.

In FIG. 12, the position of the positioning device 10(a) is set as the reference position. The distance from the estimated position of the positioning device 10(e) to the reference position is 2 in an x-axis direction and 1 in a y-axis direction. Therefore, the positioning device 10(e) transmits, for example, 3 (=2+1) as the difference when transmitting the position and the position accuracy as well as the distance and the distance accuracy. It is assumed that the positioning device 10(f) receives from the positioning device 10(e) the position and the position accuracy, the distance and the distance accuracy, and a value 3 as the difference. In this case, for example, the overall accuracy is calculated as 12 by multiplying a value 4 resulting from summing 3 of the position accuracy and 1 of the distance accuracy with a value 3 of the difference of the positioning device 10(e).

As described above, in the positioning system 100 according to the second embodiment, the overall accuracy is calculated based on the difference between the position of the target nearby device and the reference position. Therefore, the overall accuracy is calculated more accurately. As a result, an appropriate nearby device is selected and an error that occurs in position estimation can be reduced.

### Third Embodiment

A third embodiment differs from the first and second embodiments in that the positioning device 10 moves. In the third embodiment, this difference will be described and description of the same aspects will be omitted.

A case in which a function is added to the first embodiment will be described here. However, the function can also be added to the second embodiment.

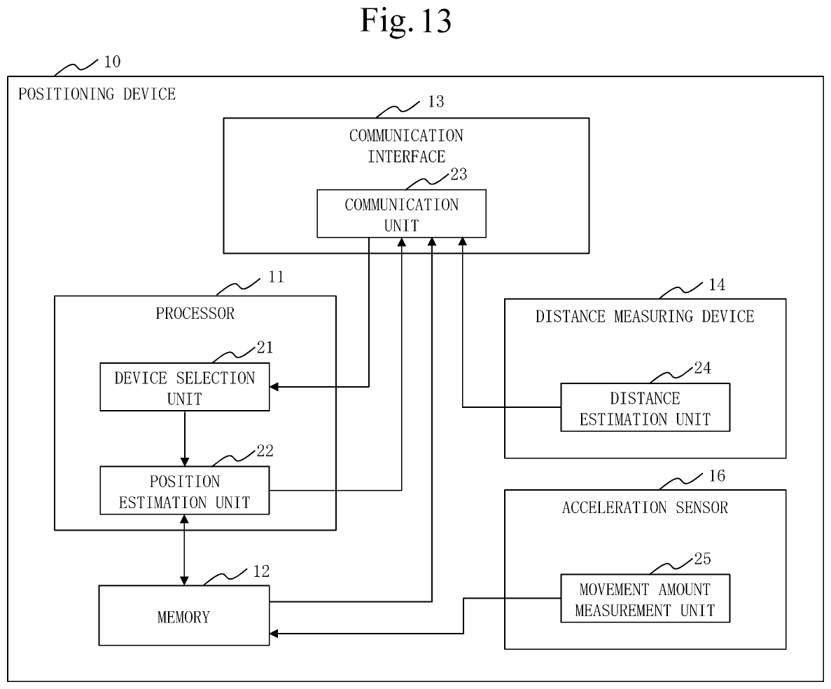

Referring to FIG. 13, a configuration of the positioning device 10 according to the third embodiment will be described.

The positioning device 10 includes an acceleration sensor 16 as hardware. The acceleration sensor 16 is a sensor that detects an acceleration of the positioning device 10. The positioning device 10 includes a movement amount measurement unit 25 as a functional component. The function of the movement amount measurement unit 25 is realized by the acceleration sensor 16.

In the first and second embodiments, the position is estimated when the positioning device 10 is installed. In the third embodiment, the positioning device 10 moves. Therefore, the positioning device 10 estimates the position not only at the time of installation but also when a condition is met.

Specifically, the movement amount measurement unit 25 measures a movement amount of the positioning device 10 and writes the movement amount in the memory 12. The movement amount measurement unit 25 determines that the position needs to be re-estimated if the movement amount after estimating the position is greater than a threshold value. When the movement amount measurement unit 25 determines that the position needs to be re-estimated, the communication unit 23 transmits estimation start requests to the positioning devices 10 in the vicinity, and newly receives positions and position accuracies as well as distances and distance accuracies from nearby devices, which are the positioning devices 10 in the vicinity, that have newly received the estimation start requests. When the positions and position accuracies as well as the distances and distance accuracies are newly received by the communication unit 23, the device selection unit 21 re-selects at least one nearby device to be used. When the nearby device to be used is re-selected by the device selection unit 21, the position estimation unit 22 re-estimates the position based on the position and distance received from the re-selected nearby device. The position estimation unit 22 also re-calculates the position accuracy based on the position accuracy and distance accuracy received from the re-selected nearby device.

The position accuracy of the estimated position may decrease as the movement amount of the positioning device 10 increases and the number of estimations increases. Therefore, the communication unit 23 of the nearby device also transmits the movement amount of the positioning device 10 when transmitting the position and the position accuracy as well as the distance and the distance accuracy. The device selection unit 21 of the positioning device 10 whose position is to be estimated calculates the overall accuracy based on the position accuracy, the distance accuracy, and the movement amount. As a specific example, the device selection unit 21 calculates the overall accuracy by weighting values obtained from the position accuracy and the distance accuracy with the movement amount.

The movement amount transmitted here may be the sum of movement amounts after the installation of the positioning device 10, or may be the movement amount per unit time after the installation of the positioning device 10.

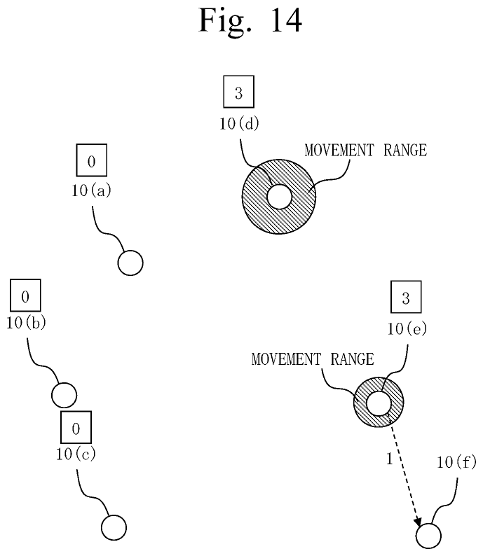

Referring to FIG. 14, an example of operation to select a nearby device to be used for position estimation in the positioning system 100 according to the third embodiment will be described.

The movement amount of the positioning device 10(e) is 5. Therefore, the positioning device 10(e) transmits 5 as the movement amount when transmitting the position and the position accuracy as well as the distance and the distance accuracy. It is assumed that the positioning device 10(f) receives from the positioning device 10(e) the position and the position accuracy, the distance and the distance accuracy, and a value 5 as the movement amount. In this case, for example, the overall accuracy is calculated as 20 by multiplying a value 4 resulting from summing 3 of the position accuracy and 1 of the distance accuracy of the positioning device 10(e) by the value 5 of the difference.

As described above, in the positioning system 100 according to the third embodiment, the position is re-estimated if the movement amount is greater than the threshold value. Therefore, an error in the position of the positioning device 10 can always be contained within a certain range.

In the positioning system 100 according to the third embodiment, the overall accuracy is calculated based on the movement amount of the positioning device 10. Therefore, the overall accuracy is calculated more accurately. As a result, an appropriate nearby device is selected, and an error that occurs in position estimation can be reduced.

In the above description, the position is re-estimated if the movement amount is greater than the threshold value. However, the position may be re-estimated at fixed time intervals. That is, the position estimation unit 22 may measure an elapsed time after estimating the position, and re-estimate the position if the elapsed time exceeds a reference time.

In the above description, the overall accuracy is calculated based on the sum of movement amounts after the installation of the positioning device 10, because the overall accuracy may decrease as the movement amount of the positioning device 10 increases and the number of estimations increases. However, if the movement amount after the most recent position estimation is large, there is a high probability that the positioning device 10 is located at a position deviated from the estimated position. Therefore, the overall accuracy may be calculated based on the movement amount after the most recent position estimation.

### Fourth Embodiment

A fourth embodiment differs from the first to third embodiments in that the overall accuracy is calculated based on the distance from a nearby device to an obstacle. In the fourth embodiment, this difference will be described and description of the same aspects will be omitted.

A case in which a function is added to the first embodiment will be described here. However, the function can also be added to the second and third embodiments.

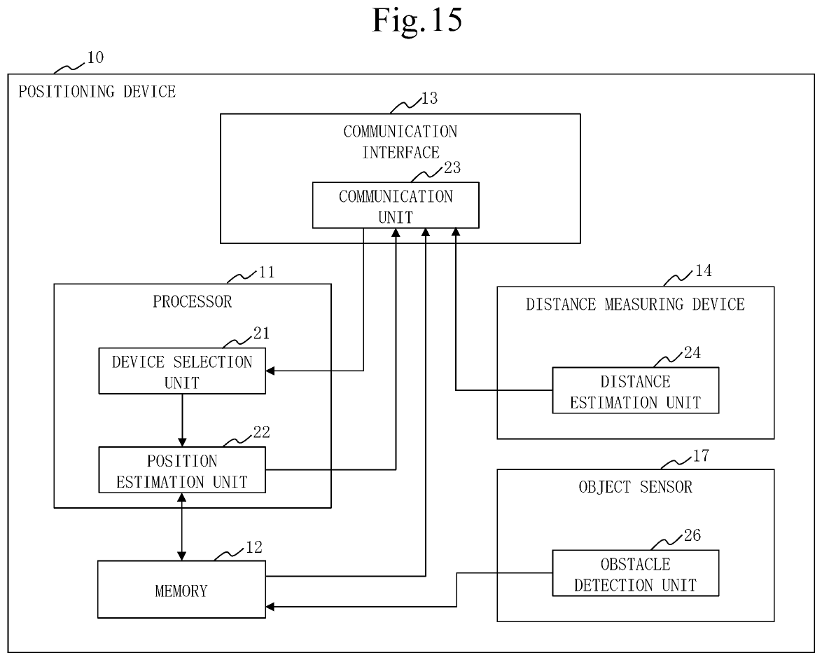

Referring to FIG. 15, a configuration of the positioning device 10 according to the fourth embodiment will be described.

The positioning device 10 includes an object sensor 17 as hardware. The object sensor 17 is a sensor that measures the distance to an obstacle such as a wall or a ceiling present in the vicinity of the positioning device 10. A specific example of the object sensor 17 is an infrared sensor or an acoustic wave sensor. The positioning device 10 includes an obstacle detection unit 26 as a functional component. The function of the obstacle detection unit 26 is realized by the object sensor 17.

The obstacle detection unit 26 measures the distance to an obstacle present in the vicinity of the positioning device 10. The communication unit 23 of a nearby device also transmits the distance to an obstacle when transmitting the position and the position accuracy as well as the distance and the distance accuracy. When there are a plurality of obstacles in the vicinity, the distance to the object closest to the nearby device is transmitted. The device selection unit 21 of the positioning device 10 whose position is to be estimated calculates the overall accuracy based on the position accuracy, the distance accuracy, and the distance to the obstacle. As a specific example, the device selection unit 21 calculates the overall accuracy by weighting values obtained from the position accuracy and the distance accuracy with the distance to the obstacle.

Media such as radio waves and acoustic waves used when the distance estimation unit 24 estimates the distance are reflected by obstacles such as walls and ceilings. Therefore, there may be a case in which an estimation result of the distance of a path through which a medium is reflected by an obstacle is obtained, in addition to an estimation result of the shortest distance to the positioning device 10, which is a distance estimation target. Therefore, when there is an obstacle near the positioning device 10, the position of the positioning device 10 may include an error. Therefore, the overall accuracy is calculated such that the shorter the distance to the obstacle, the lower the accuracy.

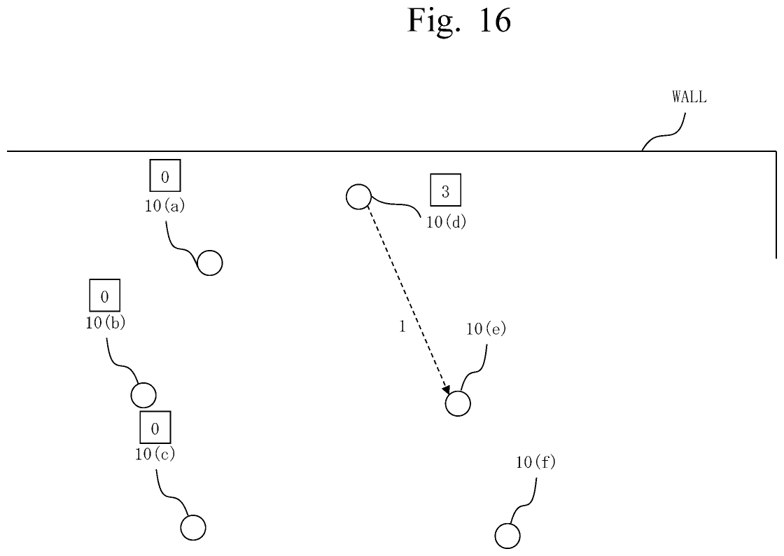

Referring to FIG. 16, an example of operation to select a nearby device to be used for position estimation in the positioning system 100 according to the fourth embodiment will be described.

In FIG. 16, there is a wall near the positioning device 10(d). It is assumed that the distance from the positioning device 10(d) to the wall is 2. Therefore, the positioning device 10(d) transmits 2 as the distance to the obstacle when transmitting the position and the position accuracy as well as the distance and the distance accuracy. It is assumed that the positioning device 10(e) receives from the positioning device 10(d) the position and the position accuracy, the distance and the distance accuracy, and a value 2 as the distance to the obstacle. In this case, for example, the overall accuracy is calculated as 2 by multiplying a value 4 resulting from summing 3 of the position accuracy and 1 of the distance accuracy of the positioning device 10(d) by a value ½, which is the reciprocal of the value 2 of the distance to the obstacle.

As described above, in the positioning system 100 according to the fourth embodiment, the overall accuracy is calculated based on the distance from the nearby device to the obstacle. Therefore, the overall accuracy is calculated more accurately. As a result, an appropriate nearby device is selected, and an error that occurs in position estimation can be reduced.

### REFERENCE SIGNS LIST

10: positioning device, 11: processor, 12: memory, 13: communication interface, 14: distance measuring device, 15: electronic circuit, 16: acceleration sensor, 17: object sensor, 21: device selection unit, 22: position estimation unit, 23: communication unit, 24: distance estimation unit, 25: movement amount measurement unit, 26: obstacle detection unit, 100: positioning system

1. A positioning device comprising:
a communication interface to treat each of a plurality of nearby devices that are present in a vicinity and whose positions are already known as a target nearby device, and receive a position of the target nearby device from the target nearby device; and
processing circuitry to:
select at least one nearby device to be used from among the plurality of nearby devices, based on an overall accuracy of the target nearby device calculated using a position accuracy that is an accuracy of the position received from the target nearby device by the communication interface and a distance accuracy that is an accuracy of a distance to the target nearby device, and
estimate a position, based on the position received from the selected nearby device and a distance to the selected nearby device.

2. The positioning device according to claim 1,
wherein the processing circuitry calculates the distance accuracy, based on a physical condition in relation to the target nearby device.

3. The positioning device according to claim 1,
wherein the processing circuitry selects a required number of nearby devices for estimating the position in descending order of the overall accuracy.

4. The positioning device according to claim 1,
wherein the processing circuitry calculates a position accuracy that is an accuracy of the estimated position, based on the position accuracy and the distance accuracy.

5. The positioning device according to claim 4,
wherein the processing circuitry calculates the position accuracy by weighting values obtained from the position accuracy and the distance accuracy with physical information in relation to the target nearby device.

6. The positioning device according to claim 1, further comprising
a distance measuring device to estimate a distance to a nearby device present in the vicinity.

7. The positioning device according to claim 1,
wherein the overall accuracy is calculated using a difference between the position of the target nearby device and a reference position.

8. The positioning device according to claim 1, further comprising
an acceleration sensor to measure a movement amount,
wherein when the measured movement amount is greater than a threshold value, the communication interface newly receives a position of the target nearby device and a distance from the target nearby device, and
wherein when positions and distances are newly received by the communication interface, the processing circuitry re-selects at least one nearby device to be used, and re-estimates a position.

9. The positioning device according to claim 1,
wherein the overall accuracy is calculated using the movement amount of a movement of the target nearby device.

10. The positioning device according to claim 1,
wherein the overall accuracy is calculated using a distance from the target nearby device to an obstacle.

11. A positioning method comprising:
treating each of a plurality of nearby devices that are present in a vicinity and whose positions are already known as a target nearby device, and receiving a position of the target nearby device from the target nearby device;
selecting at least one nearby device to be used from among the plurality of nearby devices, based on an overall accuracy of the target nearby device calculated using a position accuracy that is an accuracy of the position received from the target nearby device and a distance accuracy that is an accuracy of a distance to the target nearby device; and
estimating a position, based on the position received from the selected nearby device and a distance to the selected nearby device.

12. A positioning system comprising a plurality of positioning devices,
each of the plurality of positioning devices including
a communication interface to treat another positioning device present in a vicinity as a nearby device, treat each of a plurality of nearby devices whose positions are already known as a target nearby device, and receive a position of the target nearby device from the target nearby device; and
processing circuitry to:
select at least one nearby device to be used from among the plurality of nearby devices, based on an overall accuracy of the target nearby device calculated using a position accuracy that is an accuracy of the position received from the target nearby device by the communication interface and a distance accuracy that is an accuracy of a distance to the target nearby device, and
estimate a position, based on the position received from the selected nearby device and a distance to the selected nearby device.
